(19) United States
(12) Patent Application Publication
(10) Pub. No.: US 2007/0104929 A1
(43) Pub. Date: May 10, 2007

(54) Method for plating printed circuit board and printed circuit board manufactured therefrom

(75) Inventors: Kyu Hyok Yim, Chungcheongbuk-do (KR); Sung Wook Chun, Incheon (KR); Dek Gin Yang, Chungcheongbuk-do (KR); Dong Gi An, Gyeongsangnam-do (KR); Chul Min Lee, Chungcheongnam-do (KR); Mi Jung Han, Gyeonggi-do (KR)

Correspondence Address: STAAS & HALSEY LLP, SUITE 700, 1201 NEW YORK AVENUE, N.W., WASHINGTON, DC, 20005, US

(73) Assignees: SAMSUNG ELECTRO-MECHANICS CO., LTD., Suwon-si (KR); YMT CO., LTD., Incheon (KR)

(21) Appl. No.: 11/586,006

(22) Filed: Oct. 25, 2006

(30) Foreign Application Priority Data
Oct. 25, 2005 (KR) 10-2005-0100787

(51) Int. Cl. B05D 5/12; B32B 3/00

(52) U.S. Cl. 428/209; 427/96.1; 428/901

(57) ABSTRACT

Disclosed herein are a method for plating a printed circuit board and the printed circuit board manufactured therefrom. In the method, a bare soldering or wire bonding portion of a copper (Cu)- or copper alloy layer, is plated with palladium (Pd) or a palladium alloy, and then gold (Au) or a gold alloy is deposited over the palladium or palladium alloy plated layer by an electroless substitution plating process based on ionization tendency. Having superior hardness, ductility and corrosion resistance, palladium is suitable for use between a connector and a substrate and meets requirements for the printed circuit board even when applied to a low thickness, greatly reducing the process time. Accordingly, the problem of black pad, which frequently occur on electroless nickel and electroless gold finish upon surface mount technology, can be perfectly solved. Particularly, fatal bending cracks can be prevented from occurring in the rigid-flexible or flexible printed circuit boards.

### CROSS REFERENCE TO RELATED APPLICATION(S)

This application claims the benefit of Korean Patent Application No. 10-2005-0100787, entitled “Method for plating on printed circuit board and printed circuit board produced therefrom”, filed Oct. 25, 2005, which is hereby incorporated by reference in its entirety into this application.

### BACKGROUND OF THE INVENTION

1. Field of the Invention

The present invention relates, in general, to a method for plating a printed circuit board and printed circuit board manufactured therefrom and, more particularly, to a method for plating a printed circuit board and printed circuit board manufactured therefrom, wherein said method comprises forming a palladium or palladium alloy plated layer on a bare copper in the printed circuit board by electroless substitution plating and forming a gold or gold alloy plated layer on the palladium or palladium alloy plated layer by electroless substitution plating. The instant printed circuit board manufactured by the method is highly reliable in semiconductor packaging.

2. Description of the Related Art

Typically, most rigid, flexible, and rigid-flexible printed circuit boards (PCBs) have lands on which semiconductor components are mounted through a wire bonding process and on which elements such as IC chips, RAM, etc., are mounted through a soldering process. This can be better understood with reference to FIG. 1, which is photographs showing plan views of the PCB representative models, BGA, multi chip module (hereinafter referred to as “MCM”), and camera module. As shown in FIG. 1, it is typical for lands 2, 3 requiring a wire bonding process (hereinafter referred to as “wire bonding land”) and lands requiring a soldering process (hereinafter referred to as “soldering land”) (not shown) to be made of copper. If they remain bare or are externally exposed, the copper layers are likely to lose soldering or wire bonding properties as they oxidize or corrode over time. In order to maintain soldering or wire bonding properties, therefore, the bare or exposed copper layers are usually electroplated or electroless plated with nickel. The plated nickel layer protects the copper from an erosive atmosphere for a long period of time. In addition, the plated nickel layer plays a role as an interfacial film for preventing the copper layer and the gold layer, to be plated later, from diffusing into each other. Thereafter, wire bonding gold is plated to a thickness of around 0.5 μm in an electric or electroless manner, so as to impart properties facilitating a wire bonding process.

These plating processes are well known in the art. For example, Korean Pat. Laid-Open Publication No. 2000-53621 discloses a method for fabricating a PCB, comprising applying an electroless plated nickel phase to an exposed region of copper using a photosolder resist (PSR) to form an electroless nickel plated layer and forming a gold plated layer using a gold plating solution including at least one water-soluble gold compound, at least one conductive salt, at least one reducing agent, and water.

Korean Patent Laid-Open Publication No. 2003-0080547 suggests the introduction of a gold(Au)-silver(Ag) alloy plated layer after electroless nickel plating. Japanese Patent Laid-Open Publication No. Hei 7-7243, discloses a plating process in which an amorphous primary nickel layer and a crystalline secondary nickel layer are formed over a copper region in an electroless plating manner, followed by electroless gold plating based on a substitution reaction. Advanced techniques for the plating nickel-gold on copper are found in U.S. Pat. Nos. 5,235,139 and 6,733,823.

In a printed circuit board, thick gold plating subsequent to nickel or nickel alloy plating is conducted for the following reason.

When thin gold plating (flash gold plating, usually less than 0.1 μm) is conducted after nickel or nickel alloy plating, poor wire bondability results. A satisfactory level of wire bondability requires an increase in the thickness of the gold plated layer. Generally, a gold plated layer of 0.5 μm or greater thick shows a force of 5 gf or greater, meeting a satisfactory level of wire bondability.

In order to better understand the background of the present invention, a conventional process of plating gold on a printed circuit board is illustrated with reference to FIG. 2.

First, as seen in FIG. 2, a substrate 1 having patterned circuits (not shown) and copper layers 2 and 3 thereon is so selectively covered with a photo solder resist layer 4 that the targets of gold plating, that is, the copper layers 2 and 3, are exposed. When a CSP, a BGA, or a camera module printed circuit board is used, the exposed copper region 2 is electroplated with a nickel solution to form a nickel plated layer at least 5 μm thick, followed by the formation of a gold plated layer 7 to a thickness of at least 5 μm through an electroplating process. In this case, a lead wire is needed for the electroplating process. Also functioning as an antenna, the lead wire may cause a noise phenomenon after semiconductor assembly. Recently, it has been suggested that the lead wire be removed by etching. However, such removal is difficult to conduct perfectly.

As for an MCM printed circuit board, on the other hand, it is free of lead wires. In this case, the exposed copper region 3 is treated with an electroless nickel plating solution at 85° C. for 20 min to form a 5 μm-thick nickel-phosphorus alloy layer containing 5 to 9 wt % of phosphorus, followed by conducting a gold plating process first with a flash gold plating solution containing citric acid (primary gold plating) and then with a thick gold plating solution containing sodium thiosulfate and sodium sulfite as reducing agents (secondary gold plating) to form a gold plated layer at least 0.5 μm thick. The reason why the gold plating is conducted two times is as follows. Because the life span of the secondary plating solution is significantly reduced when it is contaminated with copper, the primary gold layer is thus employed as a buffer for protecting the second primary layer from copper.

It takes about 100 min to complete the plating process twice with the first and the second plating solution at 85° C. so as to give a gold plated layer about 0.5 μm thick. Further, the plating solutions have much short lives, giving rise to an increase in production cost.

Rigid-flexible or flexible printed circuit boards, which have come into great demand with the miniaturization and multi-functionalization of portable electronic devices, are subjected to severe process conditions, such as bending and distortion, before being sold. When subjected to such severe process conditions, printed circuit boards having electroless nickel plated and immersion gold plated layers exhibit problems fatal to their usefulness, since bending cracks are caused due to the high inherent strength of the nickel-phosphorus alloy and the structural transformation of the alloy according to thermal treatment.

For use in low current and high frequency applications, high-density PCBs must be superior in electrical properties. Although varying with the content of phosphorus, the resistivity of the conventional nickel-phosphorus alloy plated layer formed on printed circuit boards falls into a range from 50 to 80 Ω/cm. Together with such a high resistivity, the plated layer thickness amounting to 3˜6 μm causes a so-called “skin effect”, which refers to the phenomenon whereby the signal traveling through a conductor will be conducted only on the outer surface of the wire as the frequency increases. Therefore, the PCBs with nickel plated thereon are not suitable for use in low current, high frequency applications.

### SUMMARY OF THE INVENTION

Leading to the present invention, intensive and thorough research, conducted by the present inventors aiming to solve the problems encountered in the prior art, into the formation of metal plated layer on PCBs, resulted in the finding that the intercalation of a palladium or palladium alloy plated layer between a copper layer and a gold plated layer can significantly reduce the thickness of the gold plated layer without decreasing wire bondability or solderability.

Accordingly, it is an object of the present invention to provide a method for plating a printed circuit board, which assures that the printed circuit board has excellent solderability and wire bondability, and a printed circuit board fabricated therefrom.

It is another object of the present invention to provide a method for plating a printed circuit board, which can significantly reduce production costs and greatly increase productivity without the occurrence of conventional technical problems including bending cracks, and a printed circuit board fabricated therefrom.

It is a further object of the present invention to provide a method for plating a printed circuit board, which employs no lead wires, thereby allowing highly dense circuits to be formed on the board at high reliability, and a printed circuit board fabricated therefrom.

In order to accomplish the above object, an aspect of the present invention provides a method for plating a printed circuit board, comprising the steps of:

(a) providing a printed circuit board with predetermined circuit patterns, having a wire bonding portion for surface mounting semiconductors thereon and a soldering portion for connecting external parts with the printed circuit board;

(b) forming a photo solder resist layer to the remaining portions exclusive of the wire bonding portion and the soldering portion in the printed circuit board;

(c) forming an electroless palladium or palladium alloy plated layer on the wire bonding portion and the soldering portion; and

(d) immersing the palladium or palladium alloy plated layer with a substitution type immersion gold plating solution containing a water-soluble gold compound to form an electroless gold or gold alloy plated layer on the palladium or palladium alloy plated layer.

In a preferred modification of the method, the palladium alloy plated layer comprises 91 to 99.9 wt % of palladium (Pd), and 0.1 to 9.0 wt % of phosphorus (P) or boron (B).

In another preferred modification, the gold alloy plated layer comprises 99 to 99.99 wt % of gold (Au), and 0.01 to 1.0 wt % of thallium (Tl), selenium (Se) or mixture thereof.

Preferably, the palladium or palladium alloy plated layer ranges in thickness from 0.05 to 2.0 μm.

Preferably, the gold or gold alloy plated layer ranges in thickness from 0.01 to 0.25 μm.

In a further modification, the step (c) is conducted in a range from 60 to 80° C. for 1 to 30 min.

In still another modification, the step (d) is conducted in a range from 70 to 90° C. for 1 to 30 min.

The printed circuit board may be selected from a group consisting of a rigid type, a flexible type, and a rigid-flexible type.

In accordance with another aspect of the present invention, provided is a printed circuit board with predetermined circuit patterns, having a wire bonding portion for surface mounting semiconductors thereon and a soldering portion for connecting external parts with the printed circuit board, wherein each of the wire bonding portion and the soldering portion comprises:

a copper or copper alloy layer;

an electroless palladium or palladium alloy plated layer formed on a copper or copper alloy layer; and

an electroless gold or gold alloy plated layer formed on the palladium or palladium alloy plated layer.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a photograph showing tops of structures of strip-type printed circuit boards;

FIG. 2 is a view schematically illustrating a conventional plating process on a printed circuit board;

FIG. 3 is a view schematically illustrating the formation of a metal plated layer on a printed circuit board in accordance with an embodiment of the present invention;

FIG. 4A is a schematic cross sectional view showing the laminated structure of a metal plated layer formed on a printed circuit board in accordance with an embodiment of the present invention; and

FIG. 4B is a schematic cross sectional view showing the laminated structure of a metal plated layer formed on a printed circuit board in accordance with another embodiment of the present invention.

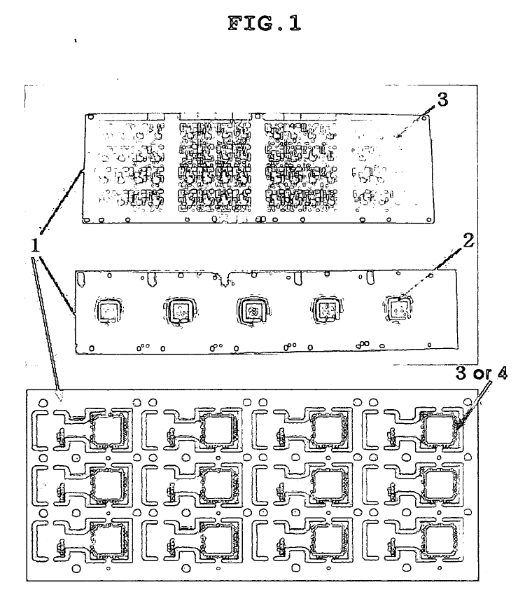

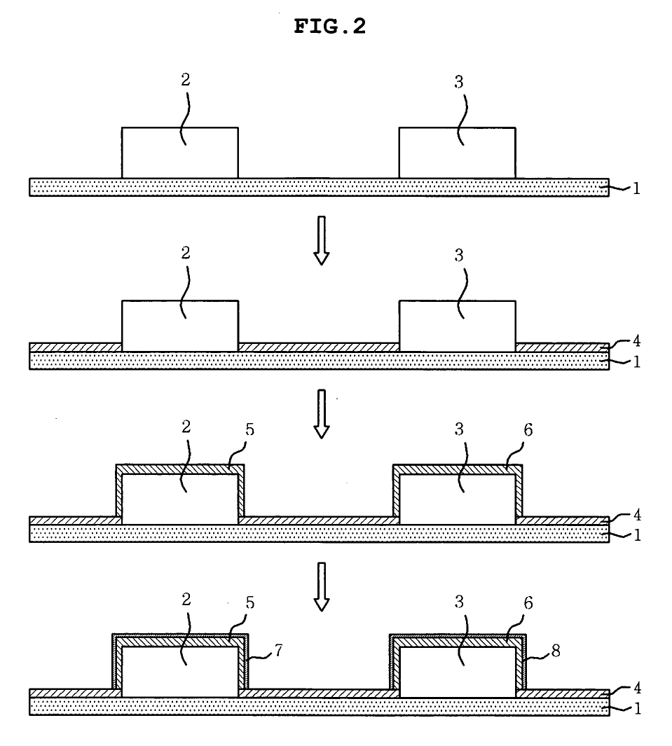

### DESCRIPTION OF THE PREFERRED EMBODIMENTS

Below, a detailed description will be given of the present invention with reference to the accompany drawings.

In the present invention, as described above, an exposed soldering or wire bonding portion as a copper (Cu)- or copper alloy layer, is plated with palladium (Pd) or a palladium alloy, and then gold (Au) or a gold alloy plated layer is formed over the palladium or palladium alloy plated layer by an electroless substitution plating process, which requires no lead wires, thereby providing high reliability for high-density rigid, flexible or rigid-flexible printed circuit boards for BGA (ball grid array), CSP (chip scale package) or camera modules, simply and at a low production cost.

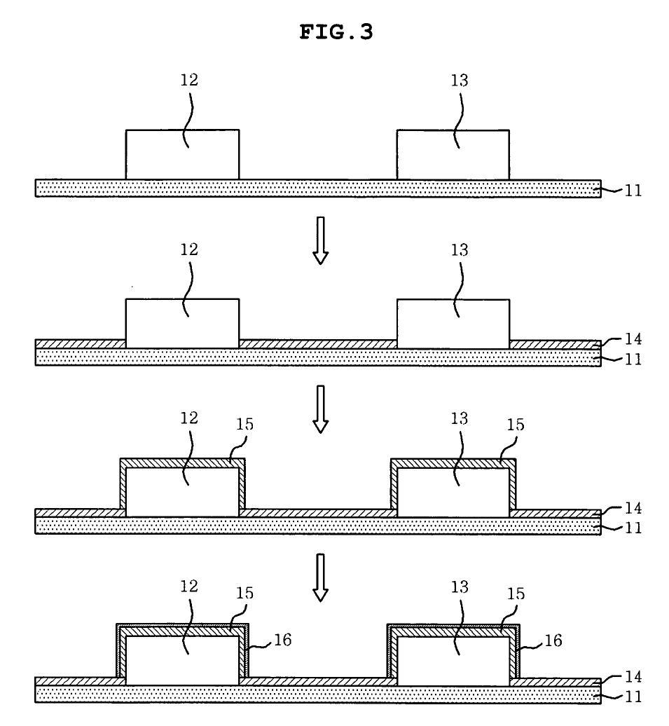

With reference to FIG. 3, a method for forming a metal plated layer on a printed circuit board is illustrated in accordance with an embodiment of the present invention.

As seen, first, a rigid, flexible or rigid-flexible substrate 11 having patterned circuits (not shown), wire bonding portions 12, 13 for interconnection of semiconductors with the substrate, and soldering portions (not shown) for interconnection with external parts, all of which are typically formed using photolithography, is covered with a photo solder resist layer 14 which acts, as will be described later, as a plating resist. Following the application of a patterned dry film on the solder resist layer 14, exposure and development processes are conducted to peel out the solder resist layer at selected regions corresponding to the wire bonding portions 12, 13 and the soldering portions (not shown).

On the wire bonding portions 12, 13 and the soldering portions (not shown) thus exposed, palladium or a palladium alloy is plated in an electroless manner to form a palladium or palladium-alloy plated layer 15. Below, a more detailed description is given of the formation of the electroless palladium or palladium alloy plated layer 15 on the electroconductive layers 12, 13.

When using sodium hypophosphite as a reducing agent, palladium may be plated on copper in the following manner.
H₂PO₂⁻+H₂O---->H₃PO₃⁻+H⁺+e⁻ [symbol] Reaction 1 [symbol]
Pd²⁺+2e⁻---->Pd⁰ [symbol] Reaction 2

[symbol]

With dimethylamineboran (DMAB) serving as a reducing agent, the electroless plating of palladium on copper can be conducted using the following Reactions 3 and 4.
(CH₃)₂NHBH₃+4OH⁻---->(CH₃)₂NH+BO₂⁻+3/2H₂+2H₂O+3e⁻ [symbol] Reaction 3 [symbol]
Pd²⁺+2e⁻---->Pd⁰ [symbol] Reaction 4

[symbol]

By way of the mechanism described by Reactions 1 to 4, palladium can be plated on copper.

In the present invention, the reducing agent employed in the plating solution determines whether pure palladium or a palladium alloy (palladium-phosphorus, palladium-boron) is plated. For example, a typical electroless palladium plating solution useful in the present invention is commercially available from Y. M. Technology, Co., LTD. in the trade name of PAGODA-Palladium, which comprises palladium sulfate (PdSO₄) as a palladium source, sodium hypophosphite or dimethylamineboran as a reducing agent, lactic acid as a complexing agent, and succinic acid as a buffer, but is not limited thereto. In order to obtain a denser structure of palladium plated layer, the pH of the electroless palladium plating solution preferably falls in the range from 4.5 to 5.5.

The palladium or palladium alloy plating process is conducted at about 60 to 80° C. for 1 to 30 min to give a palladium or palladium alloy plated layer ranging in thickness from 0.05 to 2.0 μm. A plating temperature below 60° C. or a plating time period shorter than 1 min results in a plated layer too thin to meet requirements for solderability and wire bondability necessary for the printed circuit board. On the other hand, when the plating process is conducted at higher than 80° C. or for longer than 30 min, the resulting plated layer becomes thick but excessively rigid to the extent that the flexibility of the printed circuit board is lowered. In this condition, the thickness increase rate is not high enough to satisfy the requirements for solderability and wind bondability, leading to an economic disadvantage.

The palladium or palladium alloy plated layer 15 formed through the electroless plating process preferably comprises 91 to 99.9 wt % of palladium (Pd) in combination with 0.1 to 9.0 wt % of phosphorus (P) and/or boron (B).

When the palladium alloy plated layer 15 consists of palladium-phosphorus, it preferably has a phosphorus content from 5 to 9 wt %. At a phosphorus content less then 5 wt %, the plated layer shows good solderability, but poor corrosion resistance and wire bondability. On the other hand, a phosphorous content exceeding 9 wt % improves corrosion resistance and wire bondability, but decreases solderability.

In the palladium alloy plated layer 15 consisting of a palladium-boron alloy, the content of boron (B) preferably ranges from 0.5 to 5 wt %. If the boron content is less than 0.5 wt %, good solderability is realized, but poor corrosion resistance also results. A boron content higher than 5 wt % increases hardness to the extent of fragility and decreases solderability.

Next, in order to impart solderability and wire bondability to the regions of interest, the electroless palladium or palladium alloy plated layer 15 is brought into contact with a substitution type immersing gold plating solution containing a water-soluble gold compound to form an electroless gold plated layer or gold alloy plated layer 16. The formation of the gold or gold alloy plated layer 16 on the palladium or palladium alloy plated layer 15 takes advantage of the substitution reaction based on ionization tendency as seen in the following Reaction 5.
Pd (solid)+Au (liquid)---->Au (solid)+Pd (liquid) [symbol] Reaction 5

[symbol]

According to this reaction, a gold plated layer or gold alloy plated layer 16 is formed.

An example of the electroless gold plating solution used in the present invention is commercially available from Y. M. Technology, Co., LTD, Korea, in the brand name of PAGODA-Gold, which comprises gold cyanide as a gold source, sodium nitriloacetate as a chelating agent, and citric acid as a complexing agent, but is not limited thereto. The pH of the electroless gold plating solution preferably falls into a range from 4 to 7.

This plating process is conducted at about 70 to 90° C. for 1 to 30 min to create a gold or gold alloy plated layer 16 ranging in thickness from 0.01 to 0.25 μm. A plating temperature below 70° C. or a plating time period below 1 min makes it difficult to obtain a plated layer having a uniform appearance. On the other hand, when the plating process is conducted at higher than 90° C. or for longer than 30 min, the solder resist ink is apt to be removed, and thus the gold or gold alloy plated layer is fragile.

Particularly, the gold alloy plated layer 16 formed according to the electroless gold plating process comprises 99 to 99.99 wt % of gold and 0.01 to 1 wt % of either or both of selenium (se) and thallium (Tl).

A pure gold plated layer is superior in solderability and wire bondability. In the gold alloy plated layer, thallium and/or selenium function as an underpotential deposit so as to improve the plating rate, and the deposited structure is a grain phase contributing to wire bondability.

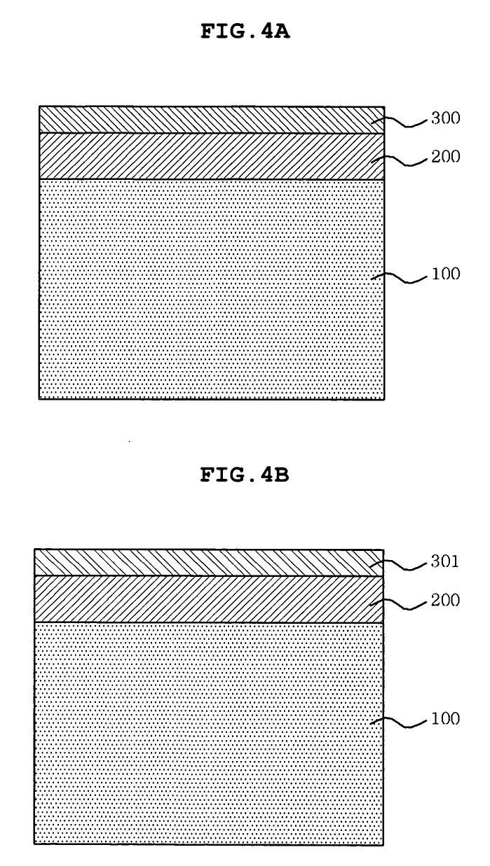

Referring to FIGS. 4A and 4B, laminated structures of the layers plated on printed circuit boards are shown.

As seen in FIGS. 4A and 4B, the layer comprises an electroless palladium or palladium alloy plated layer 200 on a copper foil 100 positioned on a wire bonding portion and a soldering portion, and a gold plated layer 300 and a gold alloy plated layer 301 formed on the palladium or palladium alloy plated layer.

With excellent solderability and wire bondability, the gold plated layer 300 or gold alloy plated layer 301 formed on the electroless palladium or palladium alloy plated layer 200 exhibits good wettability for soldering, securing elements mounted thereon.

In addition to preventing the copper or copper alloy from diffusing to external metal plated layers, the electroless palladium or palladium alloy plated layer 200 acts as a support for soldering and wire bonding. The electroless palladium or palladium alloy plated layer 200 preferably ranges in thickness from 0.05 to 2.0 μm and more preferably from 0.1 to 0.3 μm. When thinner than 0.05 μm, the electroless palladium or palladium alloy plated layer 200 cannot sufficiently protect the copper or copper alloy foil from corrosion. On the other hand, when the electroless palladium or palladium plated layer 200 is thicker than 2.0 μm, there occurs an increase in tension, leading to fragility.

The gold plated layer 300 or gold alloy plated layer 301 deposited on the electroless palladium or palladium alloy plated layer 200 preferably has a thickness from 0.01 to 0.25 μm. A gold plated layer 300 or a gold alloy plated layer 301 thinner than 0.01 μm cannot provide protection against the corrosion of the electroless palladium or palladium alloy plated layer. On the other hand, when the gold plated layer 300 or the gold alloy plated layer 301 is formed to a thickness greater than 0.25 μm, the excess thickness only slightly improves the quality, leading to an economic disadvantage, and causes the structure to be fragile.

The printed circuit board having a metal layer structure in which a copper or copper alloy layer, an electroless palladium or palladium alloy plated layer, and an electroless gold or gold alloy plated layer are laminated in ascending order enjoys the following advantages.

The first is that, because it is free of lead wires, the PCB can exclude the noise fundamentally when it is applied for BGA, CSP and camera modules, and allows as many circuits as the lead wires to be further installed thereon, so that it can be fabricated into a high-density rigid, flexible, or rigid-flexible board.

Secondly, the fabrication of the PCB can be achieved using a simple process with no requirement for removal of lead wires (e.g., etch back).

Thirdly, a flash gold plating (about 0.1 μm) can replace a thick gold plating (0.5 μm), thus decreasing the production cost by 60%.

Next, when applied to MCM or camera modules, the PCB decreases the time period of the fabrication by 60% relative to conventional ones.

Finally, there are no processes requiring electricity.

As described above, the method of plating metal on a printed circuit board in accordance with the present invention makes the fabrication of the printed circuit board simple and assures the printed circuit board of solderability and wire bondability as well as reliability. When applied to CSP, BGA or camera module printed circuit boards, the method of the present invention makes it possible to fabricate the printed circuit boards without lead wires, thereby fundamentally eliminating noise attributable to lead wires and providing a high density of circuits for the printed circuit boards. In MCM and camera module printed circuit boards, the method of the present invention can be performed in a short period of time and allows the thickness of the gold plated layer to be reduced to ⅓ of that of conventional ones, thereby reducing the production cost.

Having superior hardness, ductility and corrosion resistance, palladium can be suitable for use between a connector and a substrate and meets the requirements of the printed circuit board even when applied at a low thickness, greatly reducing the process time. Accordingly, the problem of black pad, which frequently occurs on electroless nickel and electroless gold finishes for surface mount technology, can be completely solved.

In addition, fatal bending cracks can be prevented from occurring in the rigid-flexible or flexible printed circuit boards widely used in portable electronic devices, such as mobile phones, which have increased in functionality and reduced in size. Particularly, the method for plating in accordance with the present invention can be applied to all kinds of printed circuit boards.

A better understanding of the present invention may be realized with the following examples, which are set forth to illustrate, but are not to be construed to limit the present invention.

In the following examples, a printed circuit board (size 400×505 mm, thickness 0.2±0.02 mm, copper layer thickness 10˜30 μm), entire whole surface of which, except for copper wire bonding portions and soldering portions of solder balls, was covered with a photo solder resist layer (manufactured by Daiyoink in the brand name of AS-303), was degreased at 45° C. for 3 min (using SAC 161, manufactured by Y. M. Technology, Co., LTD, Korea) and etched to the depth of 0.5˜1.0 μm (using SE 520L, manufactured by Y. M. Technology, Co., LTD, Korea) to remove oxides from the copper layer. The copper layer was catalytically treated with a palladium solution (manufactured by Y. M. Technology, Co., LTD, Korea, in the brand name of CATA 855), followed by washing with water, acid, and water in that order. Next, palladium, and then gold or a gold alloy were sequentially plated in electroless processes as described below. Following the electroless plating, a post-process was conducted using a triazole-based agent (manufactured by Y. M. Technology, Co., LTD, Korea, and marketed with the brand name POST-PAGODA) so as to impart hydrophilicity to the resulting layer before washing and drying processes.

### EXAMPLE 1

On the copper layer of the pre-treated printed circuit board, a palladium-phosphorus alloy comprised of a ratio of palladium:phosphorus 96.7:3.3 (wt %) was plated to a thickness of 0.2 μm, followed by the formation of a gold plated layer 0.05 μm thick on the palladium phosphorus alloy plated layer.

### EXAMPLE 2

The same procedure as in Example 1 was repeated, with the exception that palladium-boron alloy comprised of a ratio of palladium:boron 99.3:0.7(wt %) was used instead of palladium-phosphorus.

### EXAMPLE 3

The same procedure as in Example 1 was repeated, with the exception that pure palladium was used instead of the palladium alloy.

### EXAMPLE 4

The same procedure as in Example 1 was repeated, with the exception that the gold plated layer was 0.15 μm thick.

### EXAMPLE 5

The same procedure as in Example 1 was repeated, with the exception that the gold plated layer was 0.25 μm thick.

### EXAMPLE 6

On the copper layer of the pre-treated printed circuit board, a palladium-phosphorus alloy comprised of a ratio of palladium:phosphorus 96.7:3.3 (wt %) was plated to a thickness of 0.4 μm, followed by the formation of a gold plated layer 0.1 μm thick on the palladium phosphorus alloy plated layer.

### EXAMPLE 7

The same procedure as in Example 5 was repeated, with the exception that the palladium-phosphorus was plated to a thickness of 0.9 μm.

### EXAMPLE 8

The same procedure as in Example 1 was repeated, with the exception that the gold plated layer was formed of a gold alloy comprised of a ratio of gold (Au):Thallium (Tl) 99.98:0.01 (wt %) to a thickness of 0.15 μm.

### COMPARATIVE EXAMPLE 1

After being catalytically treated, the pre-treated printed circuit board described above was plated in an electroless process with a nickel-phosphorus alloy comprised of a ratio of nickel:phosphorus 91.3:8.7(wt %) to a thickness of 5 μm. An electroless substitution gold plating process was conducted to form a gold plated layer 0.1 μm thick.

### COMPARATIVE EXAMPLE 2

On the printed circuit board pre-treated as described above, tin (Sn) was deposited through a substitution reaction to a thickness of 1.2 μm. Following a catalytic treatment, a gold plated layer was formed to a thickness of 0.05 μm in an electroless plating process.

The metal plating was conducted in the following conditions.

In order to form a plated layer from pure palladium, palladium-phosphorus, or palladium-boron, an electroless palladium plating process was conducted at 70° C. using solutions having the compositions shown in Tables 1a, 1b and 1c.

The plating of palladium on a copper layer was achieved as described above. A plated layer thickness falling into the range according to the present invention requires a time period of about 1 to 30 min.

TABLE 1a
Composition for Electroless Plating of Pd or Pd-P Alloy

| Ingredients | Contents | | Note |
|---|---|---|---|
| Palladium chloride | 2.0 | g/l | 6 hydrates |
| sodium hypophosphite | 25 | g/l | |
| Ethylenediamine tetraacetic acid | 15 | g/l | |
| Formic acid | 20 | g/l | |
| Sodium succinate | 15 | g/l | |
| Stabilizer | 5 | ppm | |
| Accelerator | 5 | ppm | Thio compound |

Use Condition: Temp. 70° C., pH 9.0˜9.5 (adjusted with ammonia water)

TABLE 1b
Composition for Electroless Plating of Pd or Pd-B alloy

| Ingredients | Contents | | Note |
|---|---|---|---|
| Palladium sulfate | 2.0 | g/l | 6 hydrates |
| Ethylenediamine tetraacetic acid | 2.5 | g/l | |
| Lactic acid | 15 | g/l | |
| Citric acid | 10 | g/l | |
| Stabilizer | 5 | ppm | |
| Accelerator | 5 | ppm | Thio compound |

Use Condition: Temp. 70° C., pH 6.0˜7.0 (adjusted with sulfuric acid)

TABLE 1c
Composition for Electroless Plating of Pure Pd

| Ingredients | Contents | | Note |
|---|---|---|---|
| Palladium sulfate | 2.0 | g/l | 6 hydrates |
| Formic acid | 10 | g/l | |
| Ethylene diamine | 15 | g/l | |
| Sodium succinate | 10 | g/l | |
| Stabilizer | 5 | ppm | |
| Accelerator | 5 | ppm | Thio compound |

Use Condition: Temp. 70° C., pH 4.5˜5.5 (adjusted with ammonia water)

While a plating process was conducted using the plating solutions listed in the above tables, the thickness of the palladium or palladium alloy plated layer thus formed was monitored over time, and the results are given in Table 2, below.

TABLE 3
Composition for Gold or Gold Alloy Plating

| Ingredients | Contents | Note |
|---|---|---|
| Monosodium phosphate | 20˜50 g/l | |
| Sodium nitriloacetate | 50˜100 g/l | |
| Ammonium citrate | 50˜100 g/l | |
| Thallium carbonate | 10˜50 ppm | Used only in alloy plating |
| Selenium oxide | 10˜50 ppm | Used only in alloy plating |
| Gold cyanide | 2˜5 g/l | |
| Potassium cyanide | 1˜10 g/l | |

In order to form a gold plated layer or a gold alloy plated layer on the electroless palladium or palladium alloy plated layer, an electroless plating process was conducted using solutions having the compositions shown in Table 3.

TABLE 2
Change in thickness of Pd or Pd alloy plated layer over time

| Time (min) | Thickness (μm) |
|---|---|
| 1 | 0.05 |
| 5 | 0.6 |
| 10 | 1 |
| 20 | 1.6 |
| 30 | 2 |

While a plating process was conducted at 85° C. using the plating solution the pH of which was adjusted to 4.5˜5.0 with sulfuric acid, the thickness of the gold or gold alloy plated layer thus formed was monitored over time, and the results are given in Table 4, below.

TABLE 4
Change in Thickness of Au or Au Alloy plated layer over Time

| Time (min) | Thickness (μm) |
|---|---|
| 1 | 0.01 |
| 5 | 0.08 |
| 10 | 0.15 |
| 20 | 0.20 |
| 30 | 0.25 |

The plating of gold or gold alloy on the electroless palladium or palladium alloy plated layer was achieved as described above. A plated layer thickness falling into the range according to the present invention requires a time period of about 1 to 30 min.

After the formation of metal plated layers in the manner and condition described above, washing and drying at 80° C. for 15 min were conducted. The plated layers were measured for solderability and wire bondability as follows. In Table 6, results of tests for solderability, wire bondability, bendability, whisker observation and ion migration are summarized.

<Solderability>

A solder ball shear test and a solder spread test were conducted.

1) Solder Ball Shear Test

※ Conditions:

Bond Tester: DAGE 4000

Locate: 5 μm

Shear Speed: 200 μm/sec

Ball Size: 0.35 mmΦ (Alpha Metal Co.)

Ball Material: Sn/Ag/Cu (96.5/3/0.5) wt %

Flux(RMA type): EF-9301 (Alpha Metal Co.)

Reflow Machine: KOKI

Reflow Conditions: 250° C. (peak temperature)

※ Estimation:

A solder-ball shear test is typically conducted to estimate the strength of attachment of the solder-ball to the solder pad. Under the same conditions as described above, a specimen with a solder bump formed therein was fixed on a table, and the shear test was performed using a predetermined load at a predetermined shear height. The value measured upon the break of the bump by the stylus was recorded.

※ Standard for Estimation:

The ball is determined to be normal at a ball shear strength exceeding 200 gf.

2) Solder Ball Spread Test

※ Conditions:

Solder ball size: 0.35 mmΦ (Alpha Metal Co.)

Ball material: Sn/Ag/Cu (96.5/3/0.5) wt %

Flux (RMA type): EF-9301 (Alpha Metal Co.)

Reflow machine: KOKI

Reflow condition: 250° C. (peak temperature)

※ Estimation:

After fluxing the solder pad, a ball 0.35 mmΦ in size was placed on the solder pad and then allowed to pass through the reflow machine. The area of spread of the solder ball was determined. A greater area of spread indicated better solderability.

※ Standard for Estimation:

The solder ball was determined to be normal when, after reflowing, its size was three times as large as the size before reflowing (e.g., 1.05 mmΦ or larger).

<Wire Bondability>

This is to examine the bonding strength between bonding wire and bond portion. In the wire bonding tester K&S 1484, the wire bond portion was thermally aged at 175° C. for 1 hour and then subjected to the conditions given in Table 5, below.

TABLE 5
Bonding Conditions

| | Conditions |
|---|---|
| Au wire | 1 mil |
| Time (1^{st}/2^{nd}) | 15 m/sec, 25 m/sec |
| Force (1^{st}/2^{nd}) | 70 gf/100 gf |
| Power (1^{st}/2^{nd}) | 16 mW/80 mW |
| Pretreament-Heat Temp | 100° C. |
| H/B Temp. | 200° C. |

After wire bonding, the minimum and average force required to separate the wires from the portion were measured (unit: gf). Wire bondability was determined to be good if a minimum spec. of 3 or higher and an average force of 5 or higher were observed.

<Ion Migration>

※ Estimation:

On a test sample prepared according to IPC 9201, an electroless palladium or palladium alloy plated layer and an electroless gold plated layer were sequentially formed, after which the coupon was monitored for surface resistivity over 500 hours in an incubator of an SIR system in severe conditions including a relative humidity of 85%, a temperature of 85° C., and a direct current voltage of 10 volts. The water used in this test had a resistivity from 10 to 18 MΩ/cm.

※ Standard for Estimation:

Ion migration causes the plated layer to decrease in surface resistivity. When measured to have a surface resistivity of 10⁶ Ω/cm or less, the test sample was determined to have undergone ion migration, and thus to be defective.

<Bendability>

※ Estimation:

Bend radius (R)=2.0 mm

Specimen width: 1 cm

Load weight: 100 g

Bend angle: 180°

RPM=25

No. of specimen: 10 pcs.

※ Standard for Estimation:

After being bent 10 times according to the estimation condition, the specimen was determined to be acceptable if no bending cracks were observed therein.

<Whisker Test>

※ Examination:

After being allowed to stand for 1,000 hours at room temperature, the specimen was observed under a microscope to determine whether or not whiskers were produced and how long they were.

※ Standard for Estimation:

When whiskers grew to a length of 25 μm or longer, the specimen was determined to be defective.

TABLE 6
Results of Tests of Properties

| | | Examples | | | | | | | | C. Example | |
|---|---|---|---|---|---|---|---|---|---|---|---|
| | | 1 | 2 | 3 | 4 | 5 | 6 | 7 | 8 | 1 | 2 |
| Avg. | Au | 0.05 | 0.05 | 0.05 | 0.15 | 0.25 | 0.1 | 0.25 | (T1) | 0.1 | 0.05 |
| Plated | alloy) | | | | | | | | 0.15 | | |
| layer | Pd | (P) | (B) | 0.2 | (P) | (P) | (P) | (p) | (p) | | |
| μm | (alloy) | 0.2 | 0.2 | | 0.2 | 0.2 | 0.4 | 0.9 | 0.2 | | |
| | Ni | | | | | | | | | (P) | |
| | alloy) | | | | | | | | | 5 | |
| | Sn | | | | | | | | | | 1.2 |
| Solder- | Shear | 390 | 370 | 375 | 440 | 450 | 380 | 500 | 450 | 550 | 490 |
| Ability | (gf) | | | | | | | | | | |
| | Spread | 1.37 | 1.37 | 1.39 | 1.43 | 1.45 | 1.41 | 1.48 | 1.47 | 1.35 | 1.52 |
| | (mmΦ) | | | | | | | | | | |
| Wire | Min. (g) | 9.1 | 8.9 | 9.0 | 9.5 | 9.5 | 9.6 | 10.0 | 9.6 | 4.5 | 3.4 |
| Bond- | Avg. (g) | 10.8 | 10.5 | 10.7 | 11.3 | 11.6 | 11.7 | 12.2 | 11.6 | 8.6 | 5.7 |
| abilty | | | | | | | | | | | |

| | | | | | | | | | | |
|---|---|---|---|---|---|---|---|---|---|---|
| Surface | 2.8 × 10⁸ | 3.7 × 10⁸ | 8.2 × 10⁸ | 5.3 × 10⁸ | 6.0 × 10⁸ | 4.1 × 10⁸ | 6.3 × 10⁸ | 4.9 × 10⁸ | 9.8 × 10⁸ | — |
| Resistivity (Ω) | | | | | | | | | | |
| Bending Cracks | None | None | None | None | None | None | None | None | occurred | None |
| No. of Bending | ≧20 | ≧20 | ≧20 | ≧20 | ≧20 | ≧20 | ≧20 | ≧20 | 1.6 | ≧20 |
| Rounds to Crack | | | | | | | | | | |
| Occurrence | | | | | | | | | | |
| Whiskers | None | None | None | None | None | None | None | None | None | 47 μm |

※ Values of the ball shear test and the wire bonding test are the average of 20 measurements.

As seen in the results, the specimen having a gold or gold alloy plated layer on a palladium or palladium alloy plated layer meets all the requirements for properties, while bending crack defects were observed upon electroless nickel/electroless gold plating and whisker production defects were observed upon immersion thin plating.

### EXAMPLE 9

Printed circuit boards obtained in Examples 1 to 8 were tested for reliability as follows.

<Measurement of Plated Layer Thickness>

In order to examine whether they were suitable for use, the palladium or palladium alloy plated layer and the gold or gold alloy plated layer were measured for thickness using a plated layer thickness measurement system (manufactured by CMI in the brand name of CMI 900).

<Porosity Test>

Plating-treated printed circuit boards were immersed in nitric acid to examine whether the palladium or palladium alloy plated layer and the gold or gold alloy plated layer were corroded by observing the generation of pores with the naked eye.

<Heat Resistance Test>

After a printed circuit board was rendered to pass through reflow equipment three times under the conditions suggested in Table 7, below, measurement was made of whether the surface color of the palladium plated layer or the palladium and gold plated layer changed. Also, whether the palladium or palladium alloy plated layer and the gold or gold alloy were separated from each other was examined using adhesive tape.

<Adhesion Test>

Printed circuit boards were rendered to pass through reflow equipment three times under the conditions given in Table 7, below. An aluminum wire was soldered at the solder portion. The aluminum wire was pulled at a predetermined force to examine whether separation occurred between the palladium or palladium alloy plated layer and the gold or gold alloy plated layer and between the gold or gold alloy plated layer and the solder.

TABLE 7
Tests for Properties

| | | | Test | |
|---|---|---|---|---|
| | | | Results | |
| | Requirements | Test Conditions | Ex. 1 | Ex. 8 |
| plated layer | Pd or Pd alloy plated layer: 0.05 | X-ray thickness measurement | ◯ | ◯ |
| thick. | μm or thicker | system (CMI900) used | | |
| | Au or Au alloy plated layer: | | | |
| | 0.01 μm or thicker | | | |
| Porosity | No oxidation or delamination of | Immersion in 12% nitric acid | ◯ | ◯ |
| | Au or Au alloy plated layer | for 15 min | | |
| Heat | No color change or | After 3 successive passages | ◯ | ◯ |
| Resist. | delamination of Au or Au alloy | through reflow equipment, | | |
| | plated layer after tape peel test | tape peel test | | |
| | | speed: 0.7 m/min | | |
| | | Temp.: 220, 240, 250° C. | | |
| Adhesion | Delamination at boundary | After 3 successive passages | ◯ | ◯ |
| | between Cu layer and epoxy | through reflow equipment, | | |
| | | aluminum wire pulled. | | |

◯: satisfying the requirements.

In light of the results, the alloy plated layers according to the present invention are found to have physical properties meeting the requirements of the tests.

The present invention, as described hereinbefore, can be used to fabricate high-density rigid printed circuit boards on which BGA, CSP or camera modules are surface mounted because there are no additional lead wires for electric plating, and can be applied to the fabrication of rigid-flexible or flexible printed circuit boards with BGA, CSP or camera modules mounted thereon, in which both a soldering and a wire bonding process are conducted.

The method of the present invention makes it possible to omit an etch back process for unnecessary lead wires, and thus simplifies the fabrication of printed circuit boards.

In addition, the performance of wire bonding which is acquired by thick gold plating can be also obtained by plating a thin palladium or palladium alloy plated layer with gold or gold alloy, which leads to a great reduction in production cost and an improvement in productivity.

With superiority in hardness, ductility and corrosion resistance, palladium can be suitable for use between a connector and a substrate and meets requirements of the printed circuit board even at a low thickness, thus greatly reducing the process time. Accordingly, because the method of the present invention can replace conventional electroless nickel plating and electroless gold plating processes, it can be a perfect solution to the problem of black pad, which frequently occur on electroless nickel and electroless gold finishes used in surface mount technology.

Particularly, fatal bending cracks can be prevented from occurring in the rigid-flexible or flexible printed circuit boards widely used in portable electronic devices, such as mobile phones, which have increased in functionality and reduced in size.

Above all, the method for metal plating in accordance with the present invention can be applied to all kinds of printed circuit boards.

In accordance with the present invention, as described hereinbefore, an electroless pure palladium plated layer or an electroless palladium alloy plated layer consisting of palladium-phosphorus or palladium boron is formed on a copper foil of a rigid, flexible or rigid-flexible printed circuit board, and is plated with gold or gold alloy through electroless immersion plating.

In addition to protecting the palladium or palladium alloy plated layer from an external corrosion atmosphere, the resulting metal plated layer of the present invention shows excellent solderability and wire bondability and thus assures the substrate of high package reliability with semiconductors.

Because all plated layers are formed through electroless or immersion plating processes, no lead wires are needed even for BGA, CSP, and camera module printed circuit boards, with the omission of an etching back process for removing the lead wires. Accordingly, the present invention contributes to simplification of the fabrication of printed circuit boards. In addition, the absence of lead wires secures space in which additional circuits can be patterned, thereby making it possible to fabricate high-density BGA, CSP or camera modules.

In rigid, flexible or rigid-flexible printed circuit boards, such as MCM, camera modules, etc., free of lead wires, the gold on palladium plated layer, although thin, assures excellent wire bondability and can be formed in a greatly reduced time period, leading to a significant decrease in production cost and a great increase in productivity.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for plating a printed circuit board, comprising the steps of:
(a) providing a printed circuit board with predetermined circuit patterns, having a wire bonding portion for surface mounting semiconductors thereon and a soldering portion for connecting external parts with the printed circuit board;
(b) forming a photo solder resist layer to the remaining portions exclusive of the wire bonding portion and the soldering portion in the printed circuit board;
(c) forming an electroless palladium or palladium alloy plated layer on the wire bonding portion and the soldering portion; and
(d) immersing the palladium or palladium alloy plated layer with a substitution type immersion gold plating solution containing a water-soluble gold compound to form an electroless gold or gold alloy plated layer on the palladium or palladium alloy plated layer.

2. The method as set forth in claim 1, wherein the palladium alloy plated layer comprises 91 to 99.9 wt % of palladium (Pd), and 0.1 to 9.0 wt % of phosphorus (P) or boron (B).

3. The method as set forth in claim 1, wherein the gold alloy plated layer comprises 99 to 99.99 wt % of gold (Au), and 0.01 to 1.0 wt % of thallium (Ti), selenium (Se) or mixture thereof.

4. The method as set forth in claim 1, wherein the palladium or palladium alloy plated layer is 0.05 to 2.0 μm thick.

5. The method as set forth in claim 1, wherein the gold or gold alloy plated layer is 0.01 to 0.25 μm thick.

6. The method as set forth in claim 1, wherein the step (c) is conducted at 60 to 80° C. for 1 to 30 min.

7. The method as set forth in claim 1, wherein the step (d) is conducted at 70 to 90° C. for 1 to 30 min.

8. The method as set forth in claim 1, wherein the printed circuit board is selected from a group consisting of a rigid type, a flexible type, and a rigid-flexible type.

9. A printed circuit board with predetermined circuit patterns, having a wire bonding portion for surface mounting semiconductors thereon and a soldering portion for connecting external parts with the printed circuit board, wherein each of the wire bonding portion and the soldering portion comprises:
a copper or copper alloy layer;
an electroless palladium or palladium alloy plated layer formed on a copper or copper alloy layer; and
an electroless gold or gold alloy plated layer formed on the palladium or palladium alloy plated layer.

10. The printed circuit board as set forth in claim 9, wherein the palladium alloy plated layer comprises 91 to 99.9 wt % of palladium (Pd), and 0.1 to 9.0 wt % of phosphorus (P) or boron (B).

11. The printed circuit board as set forth in claim 9, wherein the gold alloy plated layer comprises 99 to 99.99 wt % of gold (Au), and 0.01 to 1.0 wt % of thallium (Ti), selenium (Se) or mixture thereof.

12. The printed circuit board as set forth in claim 1, wherein the palladium or palladium alloy plated layer is 0.05 to 2.0 μm thick.

13. The printed circuit board as set forth in claim 9, wherein the gold or gold alloy plated layer is 0.01 to 0.25 μm thick.

14. The printed circuit board as set forth in claim 9, wherein the printed circuit board is selected from a group consisting of a rigid type, a flexible type, and a rigid-flexible type.
